(19) United States
(12) Patent Application Publication
(10) Pub. No.: US 2026/0155125 A1
(43) Pub. Date: Jun. 4, 2026

(54) MUSIC SYNTHESIZER

(71) Applicant: Telepathic Pty Ltd., Moorabbin VIC (AU)

(72) Inventor: Kevin Parker, Moorabbin VIC (AU)

(21) Appl. No.: 19/398,643

(22) Filed: Nov. 24, 2025

(30) Foreign Application Priority Data
Nov. 25, 2024 (AU) 2024903884

(51) Int. Cl. G10H 1/00; G10H 1/34

(52) U.S. Cl. CPC G10H 1/0025; G10H 1/34; G10H 2210/105; G10H 2210/335; G10H 2210/571; G10H 2220/221; G10H 2220/265

(57) ABSTRACT

The present disclosure is concerned with A music synthesizer comprising: an input unit having: a note selection input for enabling a user to input a note by selecting the note from a range of notes; a chord type input for enabling the user to input a chord type; and a chord range commencement note input for enabling the user to input a chord range commencement note; and a controller in communication with the input unit, the controller being configured to: generate a plurality of chord notes for a chord, the chord characterized by: the input note as a root note of the chord; the input chord type as a type of the chord; and a chord voicing as a voicing of the chord, the chord voicing comprising one or more chord notes falling within a single octave range commencing with the input chord range commencement note; and output the generated plurality of chord notes to a sound generator.

### CROSS-REFERENCE TO RELATED APPLICATION

The present application claims priority under 35 U.S.C. § 119 to Australian App. No. 2024903884, entitled “Music Synthesizer,” filed Nov. 25, 2024, the entirety of which is incorporated by reference herein.

### TECHNICAL FIELD OF THE DISCLOSURE

The present disclosure relates generally to electronic musical instruments. The present disclosure relates more specifically to a music synthesizer that is capable of generating chords.

### BACKGROUND TO THE DISCLOSURE

Music synthesizers are known for generating audio and MIDI (or similar) signals based on user (e.g. musician) inputs and/or stored sequences. Synthesizers can generate a broad range of different audio signals for the same user input, depending on the particular configuration of the synthesizer. For example, it is known to produce multiple-note audio outputs from single note user inputs (such as produced by an octave pedal, arpeggiator or the like). However, the simple generation of multi-note outputs can lead to unpleasant or at least non-ideal progressions as the input note is changed, as no account is taken for the perception of the multi-note output changes to human listeners.

### SUMMARY OF THE DISCLOSURE

According to a first aspect of the present disclosure, there is provided a music synthesizer comprising: an input unit having: a note selection input for enabling a user to input a note by selecting the note from a range of notes; a chord type input for enabling the user to input a chord type; and a chord range commencement note input for enabling the user to input a chord range commencement; and a controller in communication with the input unit, the controller being configured to: generate a plurality of chord notes for a chord, the chord characterized by: the input note as a root note of the chord; the input chord type as a type of the chord; and a chord voicing as a voicing of the chord, the chord voicing comprising one or more chord notes falling within a single octave range commencing with the input chord range commencement; and output the generated plurality of chord notes to a sound generator.

At least in preferred embodiments, the present disclosure provides a music synthesizer that automatically generates chords based on a note selection and chord type that a user enters. The synthesizer automatically generates the constituent notes of a chord so that they fall within a 12-note (1 octave) range. The range of notes in which the generated chord notes fall is modifiable by operating the chord range commencement note input to define different starting notes for the range. Automatically confining chord notes to fall within a range provides an intuitive way for the user to produce chord progressions with rich musical texture (such as “cluster chords”) by inputting single notes. The modifiable range adds flexibility to chord production and also allows the synthesizer to have a more compact form factor by only requiring a single octave keyboard as a note selection input. This smaller form factor is particularly important for embodiments where the music synthesizer is a hardware synthesizer or functions as an external controller for software instruments.

In some embodiments, the chord range commencement note input comprises an user-operable input device that is operated to adjust the pitch of the input chord range commencement note. The user-operable input device when operated may adjust the pitch of the input chord range commencement note in semitone increments. In some embodiments, the user-operable input device comprises a dial.

The controller may generate the plurality of chord notes by selecting an inversion of the chord having chord notes falling within the single octave range.

In some embodiments, the chord type input enables selection of one or more of a diminished chord, minor chord, major chord, suspended cord, sixth cord, minor 7^{th} cord, major 7^{th} cord and ninth cord.

Typically, the note selection input is a piano keyboard, which in some embodiments is a single octave keyboard.

The music synthesizer may be one or more of a hardware synthesizer having an internal sound generator, a controller for an external software instrument to which the generated plurality of chord notes are output and a software instrument such as a plugin for digital audio workstation software.

As used herein, the word “comprise” or variations such as “comprises” or “comprising” is used in an inclusive sense, i.e. to specify the presence of the stated features but not to preclude the presence or addition of further features in various embodiments of the disclosure.

### BRIEF DESCRIPTION OF THE DRAWINGS

In order that the disclosure may be more clearly understood, embodiments will now be described, by way of example, with reference to the accompanying drawings, in which:

FIG. 1 shows a music synthesizer according to an embodiment of the present disclosure;

FIG. 2 shows a schematic representation of a controller for a music synthesizer according to an embodiment of the present disclosure;

FIGS. 3 and 4 respectively illustrate a plan view and a rear elevation view of a music synthesizer according to an embodiment of the present disclosure;

FIG. 5 shows a note selection input of a music synthesizer according to an embodiment of the present disclosure;

FIG. 6 shows a chord type input of a music synthesizer according to an embodiment of the present disclosure;

FIG. 7 shows a method for generating an audio output signal performed on a music synthesizer according to an embodiment of the present disclosure;

FIGS. 8A and 8B show an example of relative notes for a root chord and an inverted chord;

### DESCRIPTION OF EMBODIMENTS

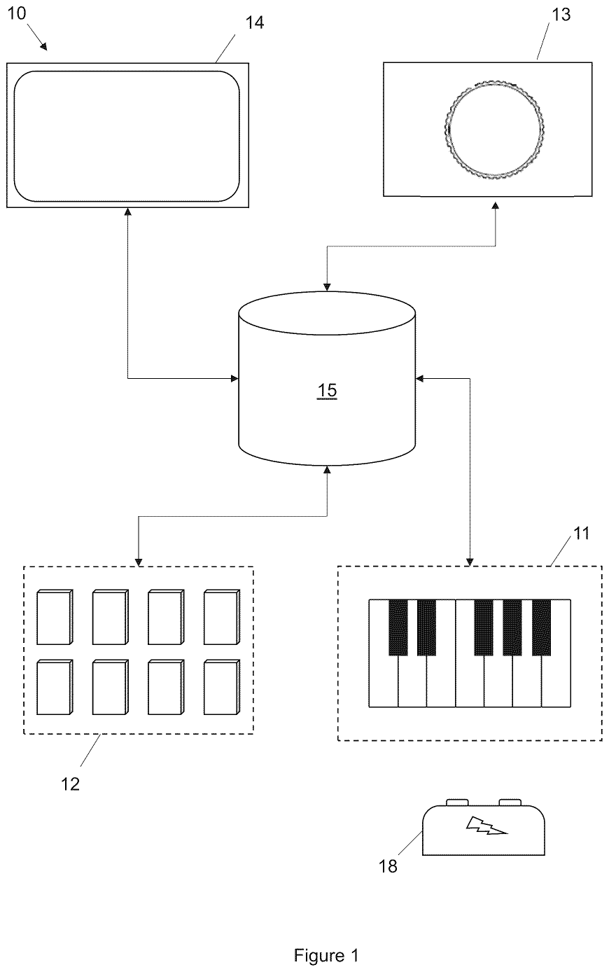

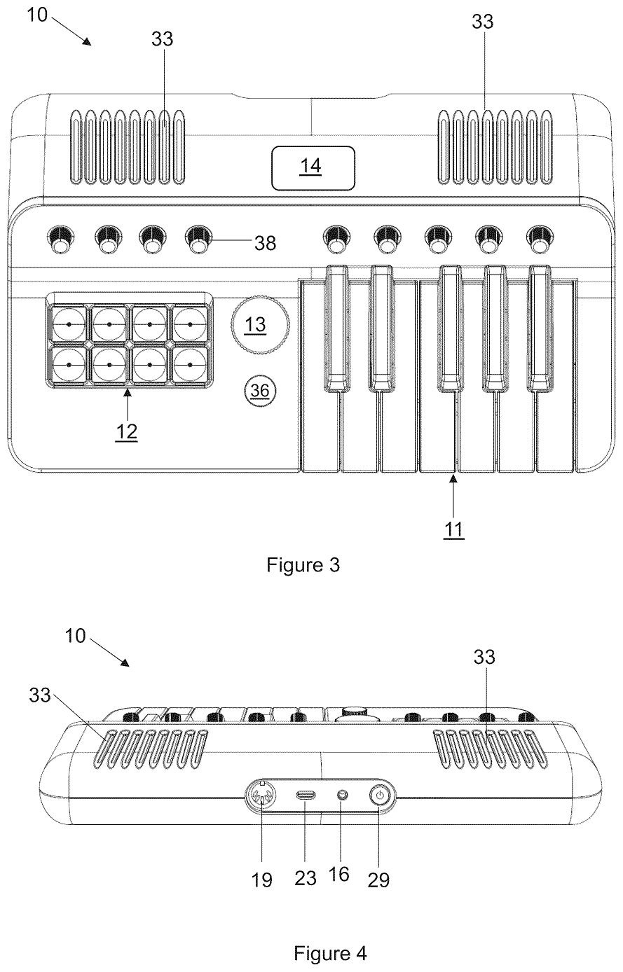

FIG. 1 shows schematically a music synthesizer 10 according to an embodiment of the present disclosure. The synthesizer 10 comprises an input unit with a note selection input 11, a chord type input 12, a chord range commencement note input 13, and a display 14, each of which is in communication with a controller 15. As shown more clearly in FIG. 4, the synthesizer 10 also comprises an audio output 16 for outputting an audio signal, a MIDI port 19 for outputting note, velocity and performance control information to an external MIDI instrument, a USB port 23 for connecting the music synthesizer 10 to music production equipment such as a PC running digital audio workstation (DAW) software, and a power button 29. The audio output 16 is coupled to an internal sound generator. The internal sound generator is also coupled to speakers 33. The audio output 16, MIDI port 19, USB port 23 and sound generator are interfaced with controller 15 via suitable BUS connections. Also shown is power supply 18 arranged to provide electrical power to the controller 15 and other components. It should be understood that the various components can be directly powered by power supply 18 or powered via another component, for example, the controller 15 can be configured to power one or more other components. The power supply 18 can comprise a battery (preferably rechargeable) and/or an external power supply port for connection to an external power supply (not shown), such as a DC power supply.

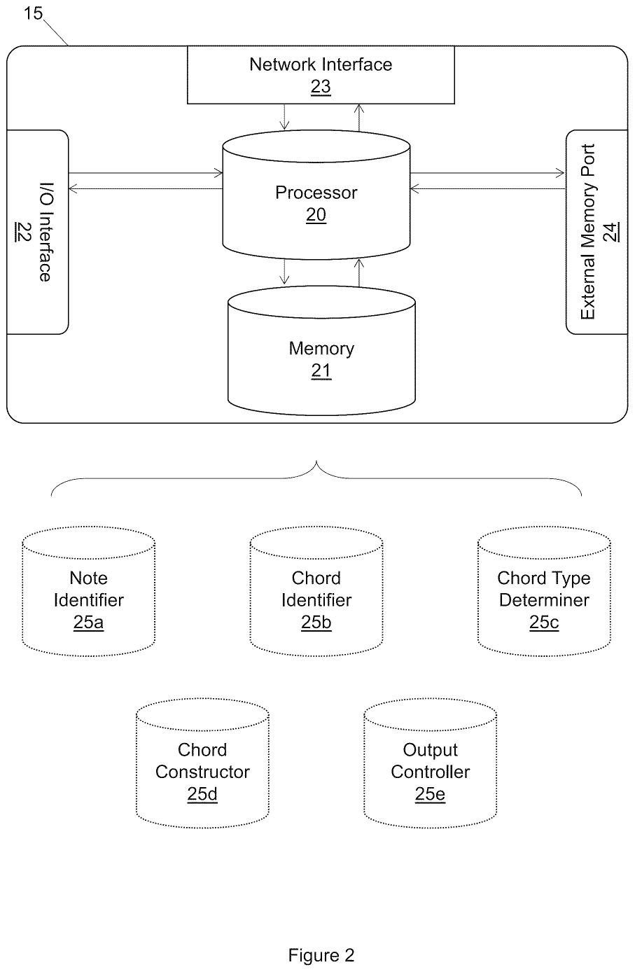

FIG. 2 shows a schematic representation of the controller 15 according to an embodiment. In a general sense, the controller 15 comprises a processor 20 interfaced with a memory 21. It should be understood that reference to “a processor 20” includes embodiments comprising multiple processors, for example, in the form of a multi-core CPU. Similarly, it should be understood that reference to “a memory 21” includes embodiments having separate physical memories, which can be of different types (e.g. volatile and non-volatile memories, random access and read only memories, etc.). The memory 21 typically holds program code to be read by the processor 20 and provides a space for storage of data related to operation of the controller 15. For example, the storage space can include a main memory for program code and data storage during operation of the controller 15 and a secondary memory for long-term (e.g. non-volatile) program code and data storage. In such a configuration, program code and data are typically loaded by the processor 20 into the main memory from the secondary memory as needed. The controller 15 also comprises an input/output (I/O) interface 22 by which the controller 15 can receive and send signals to and from the system 10 components such as the audio output 16, MIDI port 19 and USB port 23. The controller 15 optionally also comprises a network interface 23 and/or external memory port 24 to enable, for example, updating of the controller 15 and acquisition of data generated by the controller 15.

As shown also schematically in FIG. 2, the controller 15 undertakes several distinct logical functions represented by various modules 25. In the embodiment shown, the controller 15 implements a note identifier module (“note identifier”) 25a, a chord identifier module (“chord identifier”) 25b, a chord type determiner module (“chord type determiner”) 25c, chord constructor module (“chord constructor”) 25d, and an output controller module (“output controller”) 25e. The modules 25 are implemented by the processor 20 via suitable program instructions stored in the memory 21. The term “module” is not intended to denote a particular program structure as such and instead provides a convenient means to differentiate different processes undertaken by the controller 15.

Those skilled in the art will appreciate that embodiments in which the music synthesizer 10 is a software instrument (such as a plugin to DAW software), the processor 20 will typically be the processor of the host PC and the modules 25 will be implemented within the software instrument.

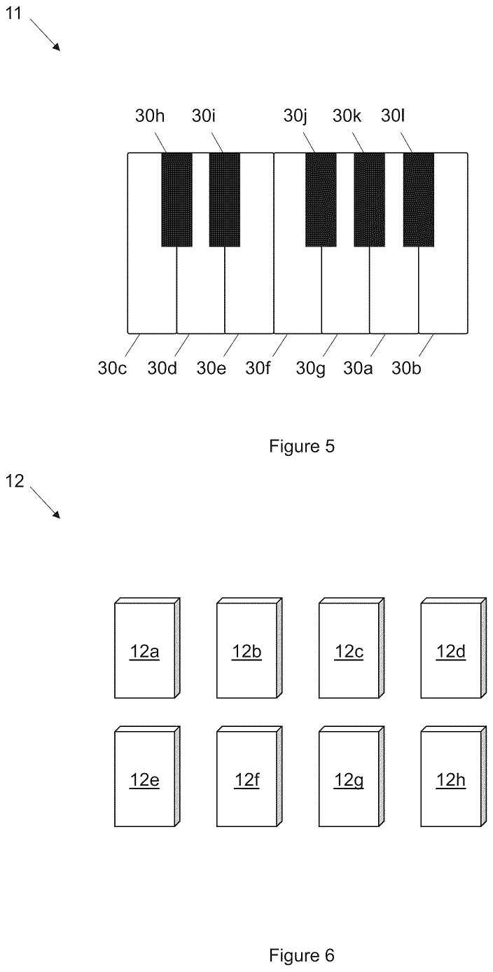

Referring to FIGS. 3 and 5, the note selection input 11 provides a means for a user to select (as a system input) a desired note and for the synthesizer 10 to play a chord with the selected note as the root note. In an embodiment, the note selection input 11 allows multiple notes to be selected simultaneously. The note selection input 11 generates a signal for the controller 15 which is processed by the note identifier module 25a. In the embodiment shown, the note selection input 11 comprises a musical keyboard. For ease of disclosure, the term “keyboard 11” is used synonymously with “note selection input 11” herein in relation to the specific embodiments described, unless specifically stated otherwise. However, it should be understood that embodiments may be provided utilising another means of note selection by a user, such as via a touchpad or touchscreen display.

In the example shown, the keyboard 11 covers a musical octave; that is, it includes means for selecting any note within a 12-note octave. Thus, the keyboard 11 includes a number of keys 30, corresponding to so-called “white” and “black” keys 30 and is similar to a sequence of twelve keys of a piano. Such a keyboard 11 can advantageously provide a familiar understanding to the user of which notes correspond to which keys. The keyboard 11 can be configured to generate signals indicating further information regarding the user interaction with the keyboard 11, for example, pressure indication (e.g. how hard a key 30 is pressed) and/or velocity indication (e.g. how quickly a key 30 is pressed, which may be correlated to a measure of how “hard” the key 30 was pressed).

Referring to FIGS. 3 and 5, the chord selection input 12 provides a means for a user to select a desired chord type. The effect of a selection of a particular note and a particular chord type by a user is discussed in more detail below. In the embodiment shown, the chord selection input 12 comprises a plurality (bank) of buttons 31. In response to a button 31 being activated, the chord selection input 12 generates a corresponding signal for the chord identifier 25b, thereby signalling to the chord identifier 25b a current chord type as selected by the user.

In the embodiment illustrated in FIG. 3, a bank of eight buttons are exemplified, allowing the user to select the following chord types: diminished, minor, major, suspended, sixth, minor 7^{th}, major 7^{th} and ninth. Those skilled in the art will appreciate that other chord types are possible.

The currently selected note and chord type are displayed on display 14. For example, when the user depresses the ‘major’ button from button bank 12 and presses the C key from keyboard 11, the processor causes the text “C maj” to be displayed on display 14.

In an implementation, a button 31 is activated only when depressed; releasing the button 31 causes it to be deactivated. This allows the user to hold down a button for a selected chord type and simultaneously press a key 30 for the synthesizer 10 to play the selected chord type and chord. For example, holding down the major button and pressing the C key on the keyboard causes the synthesizer to play the constituent notes of a C major chord.

According to an embodiment, one chord type is determined to be selected at any one time. Depending on the implementation, the chord selection input 11 can be configured to output a signal indicating at most one chord type selection or, alternatively, the chord identifier 25b can be configured to make a determination as to which single chord type is effectively selected in an event where the chord selection input 11 is indicating multiple buttons 31 being activated. In any event, the user is enabled to select a chord type. It should be understood that chord selection input 12 can comprise other input means, either as an alternative to, or in addition to, one or more buttons 31. For example, the chord selection input 12 can comprise at least one of: one or more switches, a touchscreen, and a touchpad.

In a general sense, the controller 15 is configured to determine and generate, based on signals received from the note selection input 11 and the chord selection input 12, chord notes (such as MIDI notes) or an audio output signal of such notes. The generated chord notes can be routed to an internal sound generator that produces an audio signal that is outputted through the audio output 16 and/or speakers 33. Alternatively, the generated chord notes can be outputted through the MIDI output 19 or USB port 23 to an external MIDI or software instrument.

For the purposes of this disclosure, chords are taken to be made up of two or more notes either sounded simultaneously or separately. The following discussion is not intended as a thorough investigation of musical theory but is instead intended to provide a basis for understanding the embodiments herein described, including the terminology utilised. Chords can have different numbers of simultaneously sounded notes; a combination of three notes is frequently encountered however other numbers, such as two, four, or more, are also common. A chord is characterised partly by its constituent notes. For example, the C-major chord type comprises simultaneously sounded C, E, and G notes, whereas the C-minor chord type comprises simultaneously sounded C, Eb, and G note classes.

A chord is also characterised by its root note which typically appears in the name of the chord type (the note “C” is the root note of both the C-major chord type and C-minor chord type mentioned above). The additional constituent notes of a chord type can be defined in terms of defining “intervals”—for example, a major chord type comprises the root note as well as the major-third and the perfect fifth of the scale of the root note.

Other concepts utilised by the embodiments herein described are those of chord inversions and voicings. A chord is considered in “root position” when the root note is the lowest pitched note (the “bass note”) in the resulting sounded chord. However, chords can be inverted by having a different constituent note as the bass note. There can be multiple possible inversions (or voicings) for a particular chord. For example, considering the C-major chord:

TABLE 1
Example of inversions for C-major (octave
of the root note C not specified)

| | | Order of Notes |
|---|---|---|
| Bass Note | Voicing | (lowest to highest pitched) |
| C | Root position | C-E-G or C-G-E |
| E | First inversion | E-G-C or E-C-G |
| G | Second inversion | G-C-E or G-E-C |

In the embodiments herein described, the synthesizer automatically generates the constituent notes of a chord so that they fall within a 12-note (1 octave) range defined by the keyboard 11. For example, playing a G major chord by holding the major button and pressing the G note, rather than generating the major third B and perfect fifth D, generates the B and D notes from the keyboard 11, which are below the pressed G note. Automatically confining chord notes to fall within a range provides an intuitive way for the user to produce chord progressions with rich musical texture (such as “cluster chords”) by inputting single notes.

In this regard, the Inventors have identified a need to enable users (such as musicians) to play sequences of chords without requiring a detailed knowledge of the notes required to play the particular chords. For example, users may desire to play a sequence of chords which have a desired apparent relationship with one another without necessarily being required to consider musical theory concepts. However, in the Inventors' experience, simply constructing sequences of chords based on a sequence of selected root notes can result in unpleasant, or at least, non-optimal musical experiences.

Embodiments herein described are therefore arranged to select a combination of notes that may not represent the root position chord for a selected root note. That is, embodiments are enabled to choose between the root position and one or more possible inversions when generating the notes of a chord that would fall outside of a one-octave range.

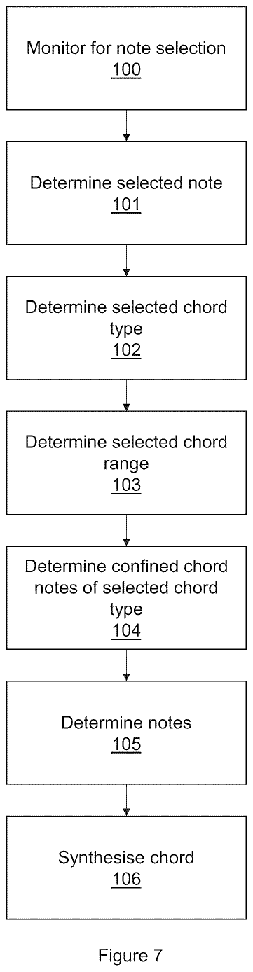

With this in mind, FIG. 7 shows a method of generating chord notes according to an embodiment. The method assumes that the synthesizer 10 has been initialised and is in a “ready” state for generating chord notes or audio signals.

The controller 15 monitors the note selection input 11 in order to identify a note selection event—for example, the pressing of a key 11 by a user, at step 100. On identifying a note selection event, the note identifier 25a is configured to determine the particular note being selected (“selected note”), at step 101.

In an embodiment, the selected note is determined by a predefined mapping between the keys 30 and notes. For example, where a keyboard 11 represents a typical keyboard beginning with a “C” note, then the selected note is simply the note that corresponds to the particular key 30.

At step 102, the chord type determiner determines, based on a currently detected state of the chord type selection input 12, a selected chord type. For example, the user may activate a button 12 known to the user to correspond to a selection of a “major” chord type. In another example, the user may activate a button 12 known to the user to correspond to a selection of a “minor” chord type. Examples of selectable chord types include: diminished, minor, major, suspended, sixth, minor 7^{th}, major 7^{th} and ninth.

At step 103, the mode determiner determines a state of the chord range commencement note input 13. The chord range commencement note input 13 enables a user to select the commencement note of an octave range from which the chord notes will be played.

At step 104, the chord constructor 25d is configured to automatically generate chord notes. That is, as a result of steps 101-102, the controller 15 has identified a selected note and a selected chord type and as a result of step 103 has determined the octave range from which the notes of the generated chord will be played.

The chord constructor 25d is configured to apply chord construction rules for determining the plurality of chord notes to generate. The particular notes are determined according to the selected chord type, the selected note and the octave-confining note selection discussed above.

The chord constructor 25d utilises a note range defining possible notes for chord synthesis. In an embodiment, the note range corresponds to a single octave, irrespective of the root position of the selected chord. In the embodiment illustrated in FIG. 3, the synthesizer 10 includes a chord voicing dial 13 that serves as a chord range commencement note input. In this regard, turning the chord voicing dial increases the pitch of the starting note of the octave range in which the chord notes are confined. For example, starting from an octave commencing on the note C3 increases the pitch in semitone increments, in the first instance to C#3. The generated chord notes are then confined to a single octave range commencing on the note C#3.

Likewise, turning the chord voicing dial decreases the pitch of the starting note of the octave range in which the chord notes are confined.

The embodiment illustrated in FIG. 3 further includes a bass voicing dial 36 that serves a corresponding function to the chord voicing dial for bass notes. The embodiment also includes a series of knobs 38 for adjusting parameters of the synthesizer such as volume and the tempo (measured in bpm) of a chord sequence that the synthesizer is programmed to generate.

In another embodiment, the note range is dynamically determined. In an embodiment where the keys 30 are dynamically mappable, the note range can be dependent on the current mapping. For example, the note range can correspond to the octave represented by the current mapping between keys 30 and note classes (e.g. an octave beginning with the note class currently mapped to lowest key 30c). This embodiment may be advantageous as the user can intuitively understand a currently selected note range as it corresponds to the currently mapped note classes to keys 30.

In an implementation, the selected chord type itself comprises relative note information defining the relative notes of the selected chord type. For example, a “major” chord is defined by the root note class, its major third (i.e. four semitones above the root note), and its perfect fifth (i.e. seven semitones above the root note). Hence, if the root note is “C”, the three generated chord notes are “C”, “E” (i.e. the major third of “C”), and “G” (i.e. the perfect fifth of “C”). However, if the root note class is “F”, then the three selected note classes for a “major” chord are “F”, “A” (i.e. the major third of “F”), and “C” (i.e. the perfect fifth of “F”). Other chord types have different relative notes: for example, a “minor chord” is defined by the root note class, its minor third (i.e. three semitones above the root note class), and its perfect fifth (i.e. seven semitones above the root note class); whereas an “augment major chord” is defined by the root note, its major third (i.e. four semitones above the root note class), and its augmented fifth (i.e. eight semitones above the root note class).

Generally, the number of generated chord notes associated with a selected chord type can be different to three. For example, a “major seventh chord” is defined by the root note, its major third (i.e. four semitones above the root note), its perfect fifth (i.e. seven semitones above the root note), and its major seventh (i.e. eleven semitones above the root note).

Other implementations can utilise different techniques for identifying the required chord notes. Relevantly, the chord constructor 25d is configured to identify a set of notes for synthesis. Typically, the set of chord notes is ordered; the notes can be understood as arranged in a sequence (typically from lowest relative pitch to highest).

In an embodiment, one or more buttons 31 are interpreted by the chord determiner 25b as modifying another selected chord type. For example, a button 31 can add a “ninth” to a selected chord type—if the selected chord type is “major” then it is modified to “major9”. In another example, a button 31 can add a sixth.

According to this embodiment, as a next step (i.e. step 105), the chord constructor 25d is configured to determine the actual set of notes for synthesis—that is, the chord constructor 25d is configured to map the set of note classes to the actual notes of the note range.

In an implementation, the chord constructor 25d first selects the note within the confined note range corresponding to the selected note to thereby construct the chord for synthesis. The chord constructor 25d identifies the next note in the set of chord notes and assigns it to the corresponding note in the note range. Therefore, the next note class can be assigned to a higher or lower pitched note than the selected note class depending on whether the corresponding note falls within the one-octave range or requires confining to the range by re-pitching. This can then be repeated for each note in the set of chord notes.

At step 106, the controller 15 then utilises the output controller 25e to either control the audio interface 17 to generate the appropriate audio output signal for outputting by the audio output 16 or control the MIDI output to output the generated chord notes along with any performance information. The audio interface 17 is controlled to synthesise the selected notes of the selected chord (as determined by the chord constructor 25d) to thereby generate the audio output signal.

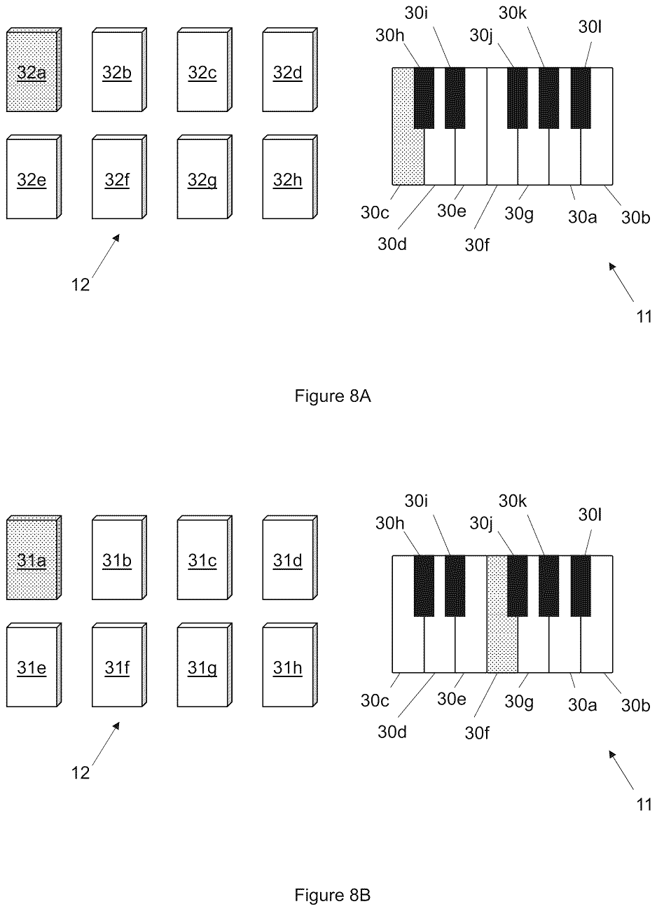

FIG. 8A shows an example in which the selected note is “C” (indicated by shading of the relevant key 30c) and the selected chord type is “major” (button 31a is assumed to correspond to the “major” chord type and is therefore also shown shaded). It is assumed for the present example that the keys 30 currently map to their usual notes, such as utilised on a standard piano. Therefore, the chord constructor 25d identifies the notes for generation or synthesis as “C”, “E”, and “G” (based on the selected note and selected chord type together indicating “C-major”). The chord constructor 25d determines that the note range is the octave beginning with “C” (in this embodiment, the current selection of note range is an octave beginning with a “C” note such as C3). The selected notes, in order of pitch, are therefore “C’, “E”, and “G”, which are derived from identifying the corresponding notes of the note range to the identified notes. Thus, the chord for synthesis is in root position as the bass note is the root note class.

FIG. 8B shows another example in which the selected note is “F” and the selected chord type is “major”. Therefore, the chord constructor 25d identifies the chord notes for generation or synthesis as “F”, “A”, and “C” (the same assumptions as per FIG. 8B). As with the example of FIG. 8A, the chord constructor 25d determines that the note range is the octave beginning with “C” (i.e. the usual note of selected key 30c of the keyboard 11). The notes for synthesis, in order of pitch, are therefore “C’, “F”, and “A”, which are derived from identifying the corresponding notes of the note range to the identified notes as confined to the single octave range. Thus, the chord for generation or synthesis is an inversion (this particular combination may be referred to as a second inversion), unlike the example of FIG. 6A.

Advantageously, if the examples of FIGS. 8A and 8B are considered to represent a chord progression from “C-major” to “F-major”, then the use of an inverted “F-major” chord may be musically preferred as the change in chord is achieved without extending the notes used outside of the selected note range. In terms of an octave, the notes are confined to within one octave despite a substantially different chord type being selected to follow the first selected chord type.

In an embodiment, the chord constructor 25d is enabled to select notes outside of the note range in certain circumstances. For example, there can be a primary note range corresponding to that already described and an expanded note range that comprises notes either or both of: immediately preceding the primary note range; and immediately following the primary note range. The expanded note range can define a particular number of notes preceding and/or following the primary note range (e.g. an absolute number such as one or two notes, or a relative number such as 50% of the size of the primary note range).

In an embodiment, the expanded note range is optionally utilised in certain circumstances by the chord constructor 25d, which can be defined as part of the chord construction rules. For example, certain chord types (or, in fact, all chord types) can utilise the expanded chord range whether the determined root note is within a certain number of notes of the upper end of the note range. This may enable the chord constructor 25d to favour certain types of chord inversions, such as favouring inversions where the second note is the same as that of the root chord (i.e. is of higher pitch than the root note).

In this example, the expanded note range can be applied to only certain note classes of the selected chord type, such as the first note class after the root note, with other note classes being selected from the primary note range.

FIG. 8A shows mode inputs 32a-32h of a mode selection input according to an embodiment. Certain mode inputs 32 affect the determination of notes for generation or synthesis whereas other mode inputs 32 affect the perception of the chord which is synthesised. In the example shown, mode inputs 32a-32e are potentiometers and mode inputs 32f-32h are switches. More generally, the mode selection input can comprise other input means, either in addition or substitution with those described herein. For example, a touchpad or touchscreen may be provided. It should also be noted that different embodiments can utilise a subset of the mode inputs 32 described.

In an embodiment, a mode input (first mode input 32a in this example) is arranged to enable the user to modify, in effect, the note range utilised by the chord constructor 25d. In the example shown, first mode input 32a is a potentiometer. The state determiner 25c is configured to interpret the potentiometer output as corresponding to discrete selections. In an implementation, the state determiner 25c is configured to identify a note range based on the currently selected note (as per note selection input 11) and the current setting of the first mode input 32a. For example, the state determiner is configured to assign the selected note to a position within an octave (i.e. somewhere between position 1 and position 12) and then to construct the note range according to the normal sequence of notes. For example, the state determiner 25c is configured to determine the output of the first mode input 32a as indicating one of the twelve positions, and to assign the selected note to the identified position.

In one position of first mode input 32a, the state determiner 25c determines the output of the first mode input 32a indicates position 1 and the selected note class is an “F”. In this case, the note range is constructed by assigning “F” to position 1 of an octave, with the note range thereby reading: F, F#/Gb, G, G#/A♭, A, A#/B♭, B, C, C#/D♭, D, D#/E♭, and E (in that order). If the user then turns the potentiometer of first mode input 32a to indicate position 6, the note range is changed such that “F” is found at position 6, thereby reading (in order): C, C#/D♭, D, D#/E♭, E, F, F#/Gb, G, G#/A♭, A, A#/B♭, and B. If at this point the user changes the selected note class, for example, to “C” while retaining first mode input 32a indicating position 6, then the note range is changed to read (in order): G, G#/A♭, A, A#/B♭, B, C, C#/D♭, D, D#/E♭, E, F, and F#/G♭.

In a variation of this embodiment, the note from which the note range is determined is predefined (either via a user input or as a fixed parameter of the system 10) while the first mode input 32a operates as described. In this case, the predefined note is assigned a position within an octave based on the current output of the first mode input 32a.

It can be preferred that the first mode input 32a (i.e. that allowing modification of the note range) is positioned such that a user can operate it while also activating one or more buttons 31 of the chord selection input 12.

In an embodiment, a mode input (second mode input 32b in this example) is arranged to enable the user to set a default chord type selection mode of operation. In effect, this mode of operation allows the chord identifier 25b to identify a chord type when no user input is made via the chord selection input 12. In the example shown, second mode input 32b is a potentiometer. The state determiner 25c is configured to interpret the potentiometer output as corresponding to discrete selections. In an embodiment, one setting of the second mode input 32b indicates that no default chord should be identified absent a user input via the chord selection input 12.

In an embodiment, the second mode input 32b can select a scale from which chord types can be selected absent a user input. The chord types identified are then based on the currently selected note class and the current scale—for example, whichever chord utilises the notes of the scale having the selected note class as its root note. It may be preferred that the identified chord type has a particular number of notes, such as three (a “triad”).

In an embodiment, a mode input (third mode input 32c in this example) allows for selection of a “preset” synthesis—that is, the user is enabled to select the audible perception of the synthesised chord. The third mode input 32c therefore does not affect the determination of notes for synthesis. The presets can effectively be stored in the memory 21 of controller 21. In the example shown, the third mode input 32c is a potentiometer having a number of discrete outputs which are interpreted by the state determiner 25c. Presets can affect the audio output according to known techniques for music synthesis.

In an embodiment, the system 10 is configurable to synthesise an output comprising more notes that those determined at step 105. In effect, additional notes can be added based on a relationship to the determined notes.

The audio output 16 is arranged to output an audio signal synthesised according to the embodiments herein described. Generally, the audio output 16 can comprise one or more different physical outputs, which can be selected from analogue and digital approaches.

In one example, the audio output 16 comprises a synthesised signal output for outputting an audio signal playable directly. That is, the synthesised signal output defines not only notes but the voicing of said notes. This may vary, for example, based on the currently selected preset and other synthesis configurations. The audio output 16 can include wired and/or wireless analogue and/or digital outputs for the synthesised signal output. For example, a mono- or stereo-RCA output can be provided for analogue output. In another example, a USB output is provided for digital output. It is also anticipated that the synthesised signal output can be via a wireless or wired data packet interface, such as Bluetooth or WiFi (IEEE802.11*) or Ethernet cable.

In another example, the audio output 16 comprises a synthesised chord signal output that does not include a synthesised signal output, such as allowing for MIDI output. In this case, further synthesis is required by an external device, such as a laptop running suitable software, before an audio output is produced. However, the system 10 in this case still provides for chord construction.

Further modifications can be made without departing from the spirit and scope of the specification.

What is claimed is:

1. A music synthesizer comprising:
an input unit having:
a note selection input for enabling a user to input a note by selecting the note from a range of notes;
a chord type input for enabling the user to input a chord type; and
a chord range commencement note input for enabling the user to input a chord range commencement note; and
a controller in communication with the input unit, the controller being configured to:
generate a plurality of chord notes for a chord, the chord characterized by:
the input note as a root note of the chord;
the input chord type as a type of the chord; and
a chord voicing as a voicing of the chord, the chord voicing comprising one or more chord notes falling within a single octave range commencing with the input chord range commencement note; and
output the generated plurality of chord notes to a sound generator.

2. The music synthesizer according to claim 1, wherein the chord range commencement note input comprises a user-operable input device that is operated to adjust the pitch of the input chord range commencement note.

3. The music synthesizer according to claim 2, wherein the user-operable input device when operated adjusts the pitch of the input chord range commencement note in semitone increments.

4. The music synthesizer according to claim 3, wherein the user-operable input device comprises a dial.

5. The music synthesizer according to claim 1, wherein the controller generates the plurality of chord notes by selecting an inversion of the chord having chord notes falling within the single octave range.

6. The music synthesizer according to claim 1, wherein the chord type input enables selection of one or more of a diminished chord, minor chord, major chord, suspended cord, sixth cord, minor 7^{th} cord, major 7^{th} cord and ninth cord.

7. The music synthesizer according to claim 1, wherein the note selection input is a piano keyboard.

8. The music synthesizer according to claim 7, wherein the piano keyboard is a single octave keyboard.

9. The music synthesizer according to claim 1, wherein the music synthesizer is a hardware synthesizer having an internal sound generator.

10. The music synthesizer according to claim 1, wherein the music synthesizer is a controller for an external software instrument to which the generated plurality of chord notes are output.

11. The music synthesizer according to any one of claim 1, wherein the music synthesizer is a software instrument such as a plugin for digital audio workstation software.

12. A computer readable medium having computer-executable instructions stored thereon which when executed by a processor, cause the processor to:
receive an input note from a note selection input;
receive an input chord type from a chord type input;
receive an input chord range commencement note from a chord range commencement note input;
generate a plurality of chord notes for a chord, the chord characterized by:
the input note as a root note of the chord;
the input chord type as a type of the chord; and
a chord voicing as a voicing of the chord, the chord voicing comprising one or more chord notes falling within a single octave range commencing with the input chord range commencement note; and
output the generated plurality of chord notes to a sound generator.

13. The medium according to claim 12, wherein the chord range commencement note input comprises a user-operable input device that is operated to adjust the pitch of the input chord range commencement note.

14. The medium according to claim 13, wherein the user-operable input device when operated adjusts the pitch of the input chord range commencement note in semitone increments.

15. The medium according to claim 12, wherein the user-operable input device comprises a dial.

16. The medium according to claim 12, wherein the processor generates the plurality of chord notes by selecting an inversion of the chord having chord notes falling within the single octave range.

17. The medium according to claim 12, wherein the computer-executable instructions execute on a hardware synthesizer having an internal sound generator.

18. The medium according to claim 12, wherein the computer-executable instructions execute on a controller for an external software instrument to which the generated plurality of chord notes are output.

19. The medium according to claim 12, wherein the computer-executable instructions execute as a software instrument such as a plugin for digital audio workstation software.
